(19) United States
(12) Patent Application Publication
(10) Pub. No.: US 2025/0214239 A1
(43) Pub. Date: Jul. 3, 2025

(54) ROBOT SYSTEM, PROCESSING METHOD, AND RECORDING MEDIUM

(71) Applicant: NEC Corporation, Minato-ku, Tokyo (JP)

(72) Inventors: Takahiro OWADA, Tokyo (JP); Tsutomu MARUYAMA, Tokyo (JP); Youko MORI, Tokyo (JP); Nobuharu KAMI, Tokyo (JP); Masatsugu OGAWA, Tokyo (JP); Hisaya WAKAYAMA, Tokyo (JP); Masumi ICHIEN, Tokyo (JP)

(73) Assignee: NEC Corporation, Minato-ku, Tokyo (JP)

(21) Appl. No.: 18/850,229

(22) PCT Filed: Mar. 30, 2022
(86) PCT No.: PCT/JP2022/016059

§ 371 Date: Sep. 24, 2024

(51) Int. Cl. B25J 9/16

(52) U.S. Cl. CPC B25J 9/1666; B25J 9/1697

(57) ABSTRACT

A robot system is configured to set a restriction on a range of a height to which a target object is lifted using a reference plane as a reference and configured to calculate a path along which the target object is moved to a movement destination based on the set restriction.

### TECHNICAL FIELD

The present disclosure relates to a robot system, a processing method, and a recording medium.

### BACKGROUND ART

Robots are used in various fields such as logistics. Some robots may operate autonomously. Patent Document 1 discloses technology related to a picking device for safely placing a target object in consideration of clearance as related technology. Moreover, Patent Document 2 discloses technology related to an article takeout apparatus for obtaining an approach path for grasping a target object as related technology.

### PRIOR ART DOCUMENTS

### Patent Document

Patent Document 1: Japanese Unexamined Patent Application, First Publication No. 2019-181573

Patent Document 2: Japanese Unexamined Patent Application, First Publication No. 2010-012567

### SUMMARY

### Technical Problem

In the technologies described in Patent Documents 1 and 2, it is difficult to avoid damage in a case where a target object falls while a robot is moving the target object to a movement destination. Therefore, an objective of the present disclosure is to provide a robot system or the like capable of reducing a possibility of damage even if a target object falls while a robot is moving the target object to a movement destination.

An objective of each example aspect of the present disclosure is to provide a robot system, a processing method, and a recording medium capable of solving the above-described problem.

### Solution to Problem

In order to achieve the above-described objective, according to an example aspect of the present disclosure, there is provided a robot system including: a setting means configured to set a restriction on a range of a height to which a target object is lifted using a reference plane as a reference; and a calculation means configured to calculate a path along which the target object will be moved to a movement destination based on the restriction set by the setting means.

In order to achieve the above-described objective, according to another example aspect of the present disclosure, there is provided a processing method including: setting a restriction on a range of a height to which a target object is lifted using a reference plane as a reference; and calculating a path along which the target object will be moved to a movement destination based on the set restriction.

In order to achieve the above-described objective, according to yet another example aspect of the present disclosure, there is provided a recording medium storing a program for causing a computer to: set a restriction on a range of a height to which a target object is lifted using a reference plane as a reference; and calculate a path along which the target object will be moved to a movement destination based on the set restriction.

### Advantageous Effects of Invention

According to each example aspect of the present disclosure, it is possible to reduce a possibility of damage even if a target object falls while a robot is moving the target object to a movement destination.

### BRIEF DESCRIPTION OF DRAWINGS

FIG. 1 is a diagram showing an example of a configuration of a robot system according to a first example embodiment of the present disclosure.

FIG. 2 is a diagram showing an example of a configuration of a control device according to the first example embodiment of the present disclosure.

FIG. 3 is a first diagram showing an example of a GUI for receiving a restriction input in the first example embodiment of the present disclosure.

FIG. 4 is a second diagram showing an example of a GUI for receiving a restriction input in the first example embodiment of the present disclosure.

FIG. 5 is a diagram showing a first example of the movement of a target object in a case where a restriction is set in the first example embodiment of the present disclosure.

FIG. 6 is a view showing a second example of the movement of a target object in a case where a restriction is set in the first example embodiment of the present disclosure.

FIG. 7 is a diagram showing a third example of the movement of a target object in a case where a restriction is set in the first example embodiment of the present disclosure.

FIG. 8 is a diagram showing an example of a configuration of a generation unit according to the first example embodiment of the present disclosure.

FIG. 9 is a diagram showing an example of a sequence of an initial plan generated by the generation unit according to the first example embodiment of the present disclosure.

FIG. 10 is a diagram showing an example of an initial plan control signal generated by a control unit according to the first example embodiment of the present disclosure.

FIG. 11 is a flowchart showing an example of a processing flow of a robot system according to the first example embodiment of the present disclosure.

FIG. 12 is a diagram showing an example of a GUI for receiving a restriction input in a second example embodiment of the present disclosure.

FIG. 13 is a diagram showing an example in which a restriction is designated using a feature object in a modified example of the second example embodiment of the present disclosure.

FIG. 14 is a diagram showing an example of an arrangement of a cushioning material in a third example embodiment of the present disclosure.

FIG. 15 is a diagram showing a robot system 1 having a minimum configuration according to an example embodiment of the present disclosure.

FIG. 16 is a flowchart showing an example of a processing flow of the robot system 1 having the minimum configuration according to the example embodiment of the present disclosure.

FIG. 17 is a schematic block diagram showing a configuration of a computer according to at least one example embodiment.

### EXAMPLE EMBODIMENT

Hereinafter, example embodiments will be described in detail with reference to the drawings.

### First Example Embodiment

A robot system 1 according to a first example embodiment of the present disclosure is a system for moving a target object M placed at a certain position to another position and is a system for reducing a possibility of damage of the target object M even if the target object M falls by providing a height to which the target object M is lifted as a restriction on a movement path of the target object M. In addition, a reference for the height to which the target object M is lifted is each of points on a reference plane. Examples of the reference plane include, in an area where the target object M can move from a movement source to a movement destination, a surface of an obstacle capable of being confirmed from a bird's-eye view in a height direction in an area where the obstacle is present and a floor surface in an area where the obstacle is absent. This floor surface forms the same surface as a pedestal 402 to be described below. Moreover, the reference plane may be a plane where an absolute value in the height direction is uniform (for example, a plane that includes a lowest point in the height direction and that is parallel to a plane including an x-axis and a y-axis in a case where the height direction is the z-axis direction and the floor surface is not a plane). The robot system 1 is, for example, a system installed in a warehouse of a logistics center. Hereinafter, in a case where “the height to which the target object M is lifted” is simply described, a reference for the height is assumed to be the reference plane. The obstacle is all physical objects other than the target object M to be moved to the movement destination by the robot 40 located within an imaging range of an imaging device 50 to be described below. Therefore, a cardboard box C to be described below containing the target object M, a container to be described below (for example, a tray T), or the like is also an obstacle.

### Configuration of Robot System

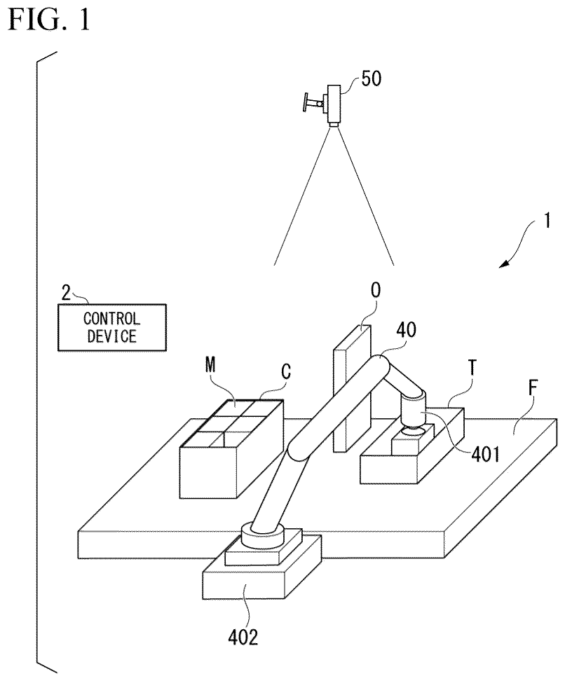

FIG. 1 is a diagram showing an example of a configuration of the robot system 1 according to the first example embodiment of the present disclosure. As shown in FIG. 1, the robot system 1 includes a control device 2, a robot 40, and an imaging device 50. In addition, in FIG. 1, an obstacle O is shown as an obstacle other than the cardboard box C or a container (for example, the tray T). Moreover, in FIG. 1, a floor F is shown.

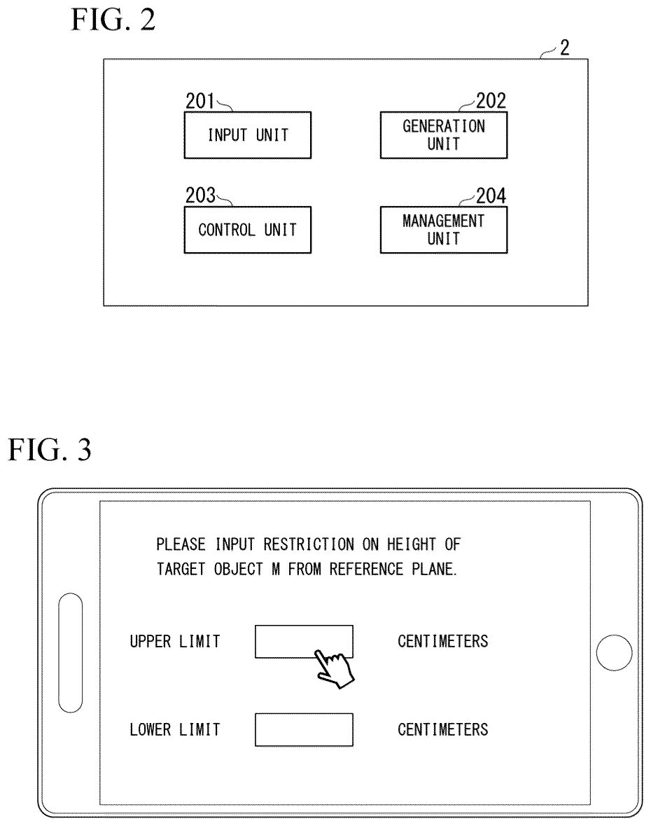

FIG. 2 is a diagram showing an example of a configuration of the control device 2 according to the first example embodiment of the present disclosure.

As shown in FIG. 2, the control device 2 includes an input unit 201, a generation unit 202, a control unit 203, and a management unit 204.

The input unit 201 inputs a work target and a restriction to the generation unit 202. Examples of the work target include information indicating types of target objects M, the number of target objects M to be moved, movement sources of the target objects M, and movement destinations of the target objects M, and the like. Examples of the restriction include an entry prohibition area in a case where the target object M is moved, a non-movable area for the robot 40, and the like. Restrictions on the entry prohibition area in a case where the target object M is moved and the non-movable area for the robot 40 include a restriction on a height to which the target object M is lifted while the target object M is moved from the movement source to the movement destination, in other words, a restriction on a height of the robot arm 401 that grasps the target object M from the reference plane to be described below. In addition, the input unit 201 may receive an input, for example, “Three parts A are moved from tray A to tray B,” as a work target from a user and identify that types of target objects M to be moved are part A, the number of target objects M to be moved is three, movement sources of the target objects M are tray A, and movement destinations of the target objects M are tray B or may input identified information to the generation unit 202. Moreover, the input unit 201 may receive a restriction on a height to which the target object M is lifted while the target object M is moved from the movement source to the movement destination (i.e., a restriction on a height to the robot arm 401 that grasps the target object M from the reference plane) as the restriction from the user and input the identified information to the generation unit 202. In addition, the restriction on the height to which the target object M is lifted may be different at a different point in the reference plane.

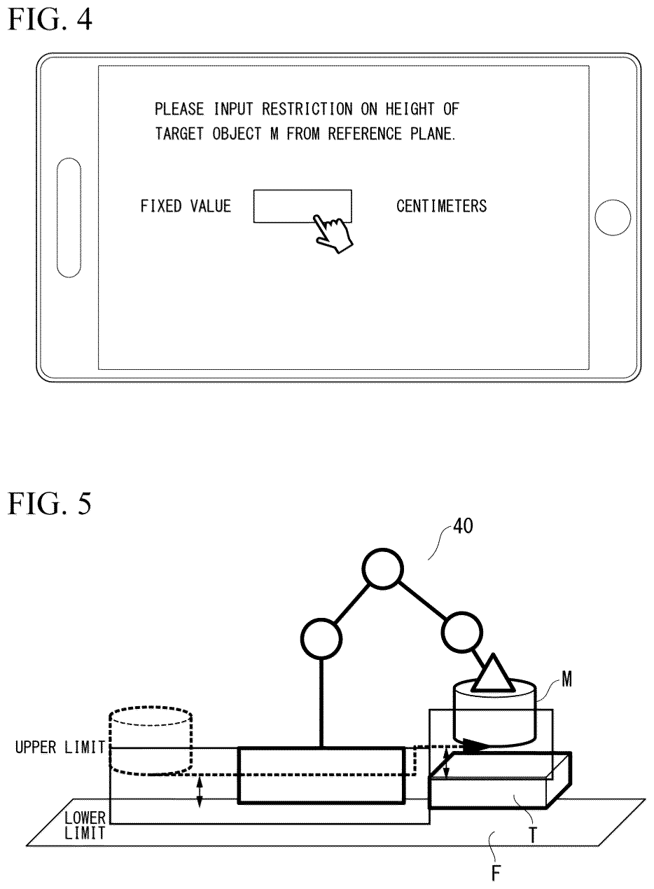

FIG. 3 is a first diagram showing an example of a GUI for receiving an input of a restriction in the first example embodiment of the present disclosure. FIG. 4 is a second diagram showing an example of a GUI for receiving an input of a restriction in the first example embodiment of the present disclosure. The input unit 201 is, for example, a display device having a function of a touch panel. In this case, the input unit 201 receives a restriction on a height to which the target object M is lifted as one of the restrictions, via a graphical user interface (GUI), for example, as shown in FIGS. 3 and 4. Examples of the reference plane include, in an area where the target object M can move from a movement source to a movement destination, a surface of an obstacle capable of being confirmed in a height direction in an area where the obstacle is present and a floor surface in an area where the obstacle is absent. Moreover, the reference plane may be a plane where a height serving as an absolute value in the height direction is uniform. The example shown in FIG. 3 is an example of a GUI in which upper and lower limits of the height to which the target object M is lifted can be set. The upper and lower limits are set within a range in which it is determined that there would be no damage even if the target object M fell. Moreover, the lower limit is set within a range in which there is no contact with the reference plane. Moreover, the example shown in FIG. 4 is an example of a GUI in which the height to which the target object M is lifted is set as a fixed value. In addition, in the GUI shown in FIG. 3, the input unit 201 may set a fixed value in a case where the user inputs the same value for the upper limit value and the lower limit value.

FIG. 5 is a diagram showing a first example of the movement of the target object M in a case where a restriction is set in the first example embodiment of the present disclosure. FIG. 5 shows the example of the movement of the target object M, in an area where the target object M can move from a movement source to a movement destination, in a case where the reference plane is a surface of an obstacle capable of being confirmed in a height direction in an area where the obstacle is present and a floor surface in an area where the obstacle is absent and the upper limit and the lower limit of the height to which the target object M is lifted are set as the restriction. In this example, a difference between the upper limit and the lower limit of the height to which the target object M is lifted set as the floor surface and the reference plane is the same as a difference between the upper limit and the lower limit of the height to which the target object M is lifted set using the surface of the obstacle (the tray T in this case) as the reference plane. In this case, the control device 2 controls the target object M so that the target object M moves between the upper and lower limits of the height set using the floor surface as the reference plane. Thereafter, the control device 2 controls the target object M so that the target object M is lifted by the height of the tray T and moves between the upper and lower limits of the height set using the surface of the obstacle as the reference plane.

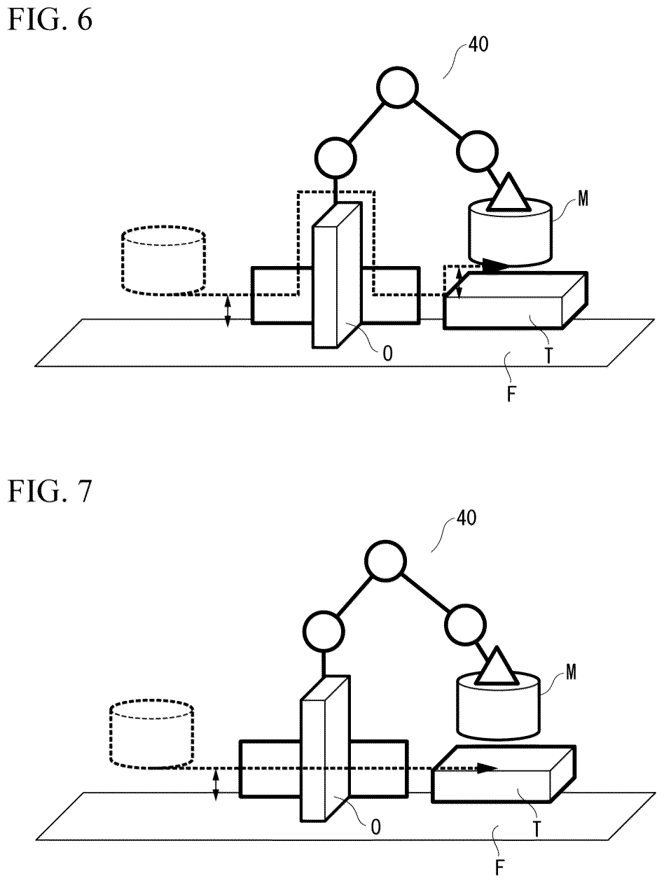

FIG. 6 is a diagram showing a second example of the movement of the target object M in a case where a restriction is set in the first example embodiment of the present disclosure. FIG. 6 shows the example of the movement of the target object M, in an area where the target object M can move from a movement source to a movement destination, in a case where the reference plane is a surface of an obstacle capable of being confirmed in a height direction in an area where the obstacle is present and a floor surface in an area where the obstacle is absent and the height to which the target object M is lifted are set to a fixed value as the restriction. In this example, the control device 2 controls the target object M so that the target object M moves at a certain height using the floor surface as the reference plane. The control device 2 controls the target object M so that the target object M is lifted to be maintained at a certain height using a surface of an obstacle O as a reference and passes the obstacle O. In a case where the target object M passes the obstacle O, the control device 2 controls the target object M so that the target object M moves at a certain height using the floor surface as a reference plane again. Also, the control device 2 controls the target object M so that the target object M is lifted by the height of the tray T and moves at a certain height using the obstacle surface as the reference plane.

FIG. 7 is a diagram showing a third example of the movement of the target object M in a case where a restriction is set in the first example embodiment of the present disclosure. FIG. 7 shows the example of the movement of the target object M in a case where a reference plane is a plane where an absolute value in the height direction is uniform (for example, a plane that includes a lowest point in the height direction and that is parallel to a plane including an x-axis and a y-axis in a case where the height direction is a z-axis direction and the floor surface is not a plane) and a height to which the target object M is lifted is set to a fixed value as the restriction. In this example, the control device 2 controls the target object M so that the target object M moves at a certain height at which the floor surface is used as the reference plane. In addition, in a case where the fluctuation in the height of the target object M in a vertical direction is small or little, it is possible to reduce a possibility that the robot 40 will drop the target object M.

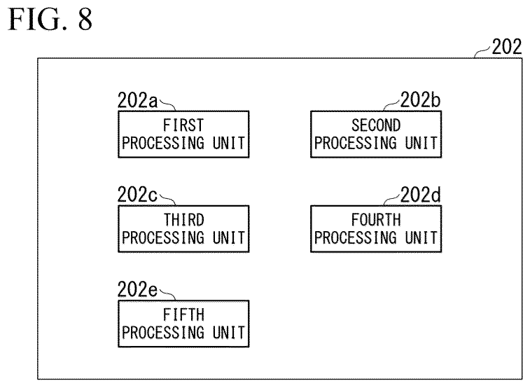

FIG. 8 is a diagram showing an example of a configuration of the generation unit 202 according to the first example embodiment of the present disclosure. As shown in FIG. 8, the generation unit 202 includes a first processing unit 202a, a second processing unit 202b, a third processing unit 202c, a fourth processing unit 202d, and a fifth processing unit 202e.

The first processing unit 202a recognizes the robot 40. For example, the first processing unit 202a recognizes a robot model using computer-aided design (CAD) data. The CAD data includes information indicating a shape of the robot 40 and information indicating a movable range such as a reach range of the robot arm 401. The shape includes dimensions. The CAD data is, for example, drawing data designed in CAD.

Moreover, the first processing unit 202a recognizes a surrounding environment of the robot 40. For example, the first processing unit 202a acquires an image captured by the imaging device 50. The image captured by the imaging device 50 includes information captured by a camera and information of a depth direction. This information of the depth direction corresponds to colored point cloud data to be described below. The first processing unit 202a recognizes a position and shape of the obstacle from the acquired image. The obstacle here is all physical objects other than the target object M to be moved to the movement destination by the robot 40 located within an imaging range of the imaging device 50. As will be described below, the imaging device 50 can acquire three-dimensional information of a physical object within the imaging range. Therefore, the first processing unit 202a can recognize a surrounding environment of the robot 40 including the position and shape of the obstacle. In addition, the first processing unit 202a is not limited to a process of recognizing the surrounding environment of the robot 40 from the image captured by the imaging device 50. For example, the first processing unit 202a may recognize the surrounding environment of the robot 40 using a three-dimensional occupancy map (Octomap), CAD data, augmented reality (AR) markers, and the like. This CAD data includes information indicating the shape of the obstacle. Dimensions are included in the shape.

Moreover, the first processing unit 202a recognizes a release position at the movement destination of the target object M. For example, in a case where the movement destination is a container (for example, the tray T), the first processing unit 202a recognizes the release position by performing machine learning using model-based matching. The model-based matching is a method of deciding a position and posture of a physical object by performing the comparison with a shape and structure data for the physical object extracted from the image using the image data obtained from the camera or the like and the shape and structure data of the physical object (the container in this case) whose position and posture are desired to be acquired. In addition, the first processing unit 202a is not limited to a process of recognizing the release position by performing machine learning using model-based matching. For example, the first processing unit 202a may recognize the release position using an AR marker.

Moreover, the second processing unit 202b recognizes the pedestal 402 of the robot 40 to be described below. For example, the second processing unit 202b recognizes the pedestal 402 by acquiring CAD data. This CAD data includes information indicating the shape of the pedestal 402. Dimensions are included in the shape. Thereby, the second processing unit 202b can recognize a Z-coordinate of the upper surface of the pedestal 402 in the coordinate system as the height of the pedestal 402. In addition, in the absence of CAD data for the pedestal 402, the second processing unit 202b may extract information of the work surface of the pedestal 402 according to a plane equation and recognize an average value of Z-coordinates of a point cloud in its coordinate system as the height of the pedestal 402.

The third processing unit 202c determines whether or not it is necessary to maintain the target object M. For example, the third processing unit 202c maintains the target object M in a case where a flag is set based on the flag indicating whether or not it is necessary to maintain the target object M. Moreover, the third processing unit 202c does not maintain the target object M in a case where the flag is not set.

Moreover, the third processing unit 202c recognizes a state (i.e., a position and posture) of the target object M. For example, the third processing unit 202c recognizes the position of the target object M by performing machine learning using model-based matching. Moreover, the third processing unit 202c recognizes the posture of the target object M by using technology for generating a bounding box such as, for example, an axis-aligned bounding box (AABB) or an oriented bounding box (OBB), with respect to the target object M whose position is identified. In addition, the third processing unit 202c may classify the target object M using clustering, which is a machine learning method, or the like with respect to an image captured by the imaging device 50 and identify a state of the target object M using technology for generating a bounding box.

Moreover, the third processing unit 202c acquires the height of the target object M. For example, the third processing unit 202c acquires CAD data to recognize the target object M. This CAD data includes information indicating the shape of the target object M. Dimensions are included in the shape. Thereby, the third processing unit 202c can recognize a Z-coordinate of the target object M in its coordinate system as the height of the target object M. In addition, the third processing unit 202c may recognize the height of the target object M by subtracting a Z-coordinate of the pedestal 402 from a Z-coordinate of the upper surface of the target object M.

The fourth processing unit 202d sets a range of a height to which the target object M is lifted. For example, the fourth processing unit 202d receives lifting height setting information for each target object M input from the input unit 201 via the GUI. Moreover, the fourth processing unit 202d may receive the lifting height setting information for each target object M from a pre-provided configuration file including information of the range of the height to which the target object M is lifted. Also, the fourth processing unit 202d stores the received lifting height setting information for each target object M. Thereby, the lifting height setting information for each target object M is set.

In addition, there are some target objects M that are unlikely to be damaged even if they fall. It is not necessary to set the range of the height to which the target object M is lifted for each of these target objects M. Therefore, status information indicating that the range of the height to which the target object M is lifted is set (for example, “1”) and status information indicating that the range of the height to which the target object M is lifted is not set (for example, “0”) may be set.

The fifth processing unit 202e generates an initial plan sequence indicating a flow of an operation of the robot 40 based on a work target determined by processing of the first processing unit 202a, the second processing unit 202b, and the third processing unit 202c and restrictions including a restriction on a range of a height to which a target object M is lifted determined by processing of the fourth processing unit 202d. For example, the fifth processing unit 202e acquires the work target from the first processing unit 202a, the second processing unit 202b, and the third processing unit 202c. Moreover, the fifth processing unit 202e acquires the range of the height to which the target object M is lifted from the fourth processing unit 202d. The fifth processing unit 202e adds a restriction on the acquired range of the height to which the target object M is lifted to the restriction input from the input unit 201. Also, the fifth processing unit 202e generates information indicating a state of the robot 40 at each time step on the way (a type of the target object M, a position and posture of the robot 40, the strength of grasping of the target object M, an operation of the robot 40 (including, for example, a reach operation for moving toward the target object M, a pick operation for picking the target object M, an arm movement operation for correctly moving a picked physical object to a transport destination, a release operation for placing a physical object, and the like), and the like) from a state in the movement source of the target object M to a state in a movement destination of the target object M necessary for the control unit 203 to generate a control signal for controlling the robot 40 based on the acquired work target and restrictions. That is, the information indicating the state of the robot 40 at each time step on the way from the state in the movement source of the target object M to the state in the movement destination of the target object M necessary for the control unit 203 to generate a control signal for controlling the robot 40 is a sequence. The fifth processing unit 202e outputs the sequence that has been generated to the control unit 203 and the management unit 204. In addition, the fifth processing unit 202e may be implemented using artificial intelligence (AI) technology including temporal logic, reinforcement learning, optimization technology, and the like.

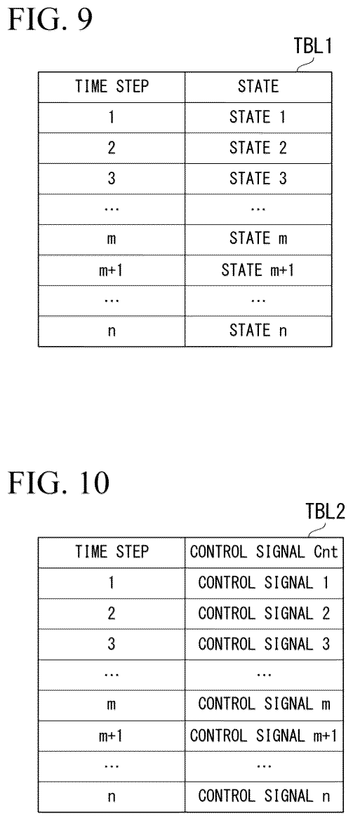

FIG. 9 is a diagram showing an example of an initial plan sequence TBL1 generated by the generation unit 202 according to the first example embodiment of the present disclosure. For example, as shown in FIG. 9, the initial plan sequence TBL1 generated by the generation unit 202 is, for example, a sequence indicating the state of the robot 40 at each time step of n from the movement source to the movement destination of the target object M.

The control unit 203 generates a control signal for controlling the robot 40 based on a sequence input from the outside (i.e., the generation unit 202). In addition, the control unit 203 may generate a control signal for optimizing an evaluation function in a case where the control signal is generated. Examples of the evaluation function include a function indicating an amount of energy consumed by the robot 40 in a case where the target object M is moved, a function indicating a distance along a path for moving the target object M, and the like. The control unit 203 outputs the generated control signal to the robot 40 and the management unit 204.

FIG. 10 is a diagram showing an example of an initial plan control signal Cnt generated by the control unit 203 according to the first example embodiment of the present disclosure. For example, as shown in FIG. 10, the initial plan control signal Cnt generated by the control unit 203 is, for example, a control signal at each time step of n from the movement source to the movement destination of the target object M.

The robot 40 includes the robot arm 401 and the pedestal 402. The robot arm 401 is connected to the pedestal 402. The robot arm 401 grasps the target object M in accordance with the control signal output by the control unit 203 and moves the target object M from the movement source to the movement destination.

The imaging device 50 captures a state of the target object M. The imaging device 50 is, for example, a depth camera, which can identify the state (i.e., a position and posture) of the target object M. The image captured by the imaging device 50 is indicated by, for example, colored point cloud data, and includes three-dimensional information of a captured physical object. The imaging device 50 outputs the captured image to the generation unit 202.

The management unit 204 estimates current states of the robot 40 and the target object M based on the sequence output by the generation unit 202 and the control signal output by the control unit 203. The current states of the robot 40 and the target object M estimated by the management unit 204 are ideal states in which the robot 40 and the target object M should be like this at a current point in time.

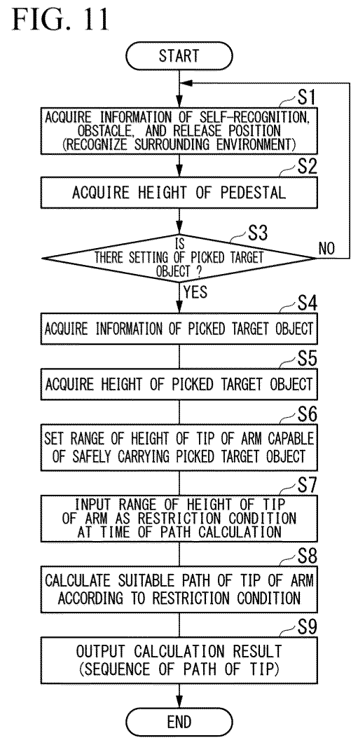

FIG. 11 is a diagram showing an example of a processing flow of the robot system 1 according to the first example embodiment of the present disclosure. Next, a process to be performed by the robot system 1 will be described with reference to FIG. 11.

The first processing unit 202a recognizes a surrounding environment of the robot 40 (step S1). For example, the first processing unit 202a acquires an image captured by the imaging device 50. The first processing unit 202a recognizes a position and shape of an obstacle from the acquired image. Moreover, the first processing unit 202a recognizes a release position at a movement destination of the target object M. For example, in a case where the movement destination is a container (for example, the tray T), the first processing unit 202a recognizes a release position by performing machine learning using model-based matching.

The second processing unit 202b recognizes the pedestal 402 of the robot 40 (step S2). For example, the second processing unit 202b acquires CAD data to acquire the height of the pedestal 402.

The third processing unit 202c determines whether or not it is necessary to maintain the target object M (step S2). For example, the third processing unit 202c maintains the target object M in a case where the flag is set based on a flag indicating whether or not to maintain the target object M. Moreover, the third processing unit 202c does not maintain the target object M in a case where the flag is not set.

In a case where it is determined that it is necessary to maintain the target object M (there is a setting of a picked target object in FIG. 11) (YES in step S3), the third processing unit 202c recognizes a state (i.e., a position and posture) of the target object M (step S4). For example, the third processing unit 202c recognizes the position and posture of the target object M using model-based matching, machine learning, and technologies for generating a bounding box such as an AABB or an OBB.

The third processing unit 202c acquires a height of the target object M (step S5). For example, the third processing unit 202c recognizes the target object M by acquiring CAD data.

The fourth processing unit 202d sets a range of a height to which the target object M is lifted (step S6). For example, the fourth processing unit 202d receives lifting height setting information for each target object M input from the input unit 201 via the GUI.

The fifth processing unit 202e generates an initial plan sequence indicating a flow of an operation of the robot 40 based on a work target determined by processing of the first processing unit 202a, the second processing unit 202b, and the third processing unit 202c and restrictions including a restriction on a range of a height to which a target object M is lifted determined by processing of the fourth processing unit 202d.

For example, the fifth processing unit 202e acquires the work target from the first processing unit 202a, the second processing unit 202b, and the third processing unit 202c. Moreover, the fifth processing unit 202e acquires the range of the height to which the target object M is lifted from the fourth processing unit 202d (step S7). The fifth processing unit 202e adds a restriction on the acquired range of the height to which the target object M is lifted to the restriction input from the input unit 201. Also, the fifth processing unit 202e generates (calculates) information indicating a state of the robot 40 at each time step on the way (a type of the target object M, a position and posture of the robot 40, the strength of grasping of the target object M, an operation of the robot 40 (including, for example, a reach operation for moving toward the target object M, a pick operation for picking the target object M, an arm movement operation for correctly moving a picked physical object to a transport destination, a release operation for placing a physical object, and the like), and the like) from a state in the movement source of the target object M to a state in a movement destination of the target object M necessary for the control unit 203 to generate a control signal for controlling the robot 40 based on the acquired work target and restrictions (step S8). That is, the information indicating the state of the robot 40 at each time step on the way from the state in the movement source of the target object M to the state in the movement destination of the target object M necessary for the control unit 203 to generate a control signal for controlling the robot 40 is a sequence. The fifth processing unit 202e outputs the generated sequence to the control unit 203 and the management unit 204 (step S9).

Moreover, in a case where the third processing unit 202c determines that it is not necessary to maintain the target object M (there is no setting of the picked target object in FIG. 11) (NO in step S3), the robot system 1 calculates a path under a condition that the restrictions do not include the restriction on the range of the height to which the target object M is lifted, moves the target object M to the movement destination along the path, and returns to the processing of step S1.

### Advantage

The robot system 1 according to the first example embodiment of the present disclosure has been described above. In the robot system 1, the fourth processing unit 202d (an example of a setting means) sets the restriction on the range of the height to which the target object M is lifted using the reference plane as the reference. The fifth processing unit 202e (an example of a calculation means) calculates a path for moving the target object M to the movement destination based on the restriction set by the fourth processing unit 202d.

Thereby, the robot system 1 can reduce a possibility of damage even if the target object falls while the robot is moving the target object to the movement destination.

### Second Example Embodiment

Next, a robot system 1 according to a second example embodiment of the present disclosure will be described. The robot system 1 according to the second example embodiment calculates a path along which a target object M is moved to a movement destination using a restriction for further limiting a movement range of the target object M by a user with respect to the restrictions in the robot system 1 according to the first example embodiment.

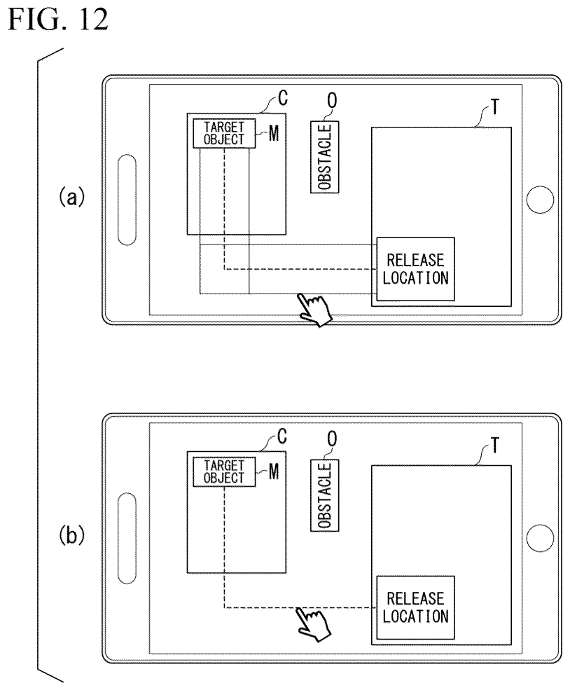

FIG. 12 is a diagram showing an example of a GUI for receiving a restriction input in a second example embodiment of the present disclosure. For example, as shown in a portion of FIG. 12(a), in a state in which the target object M, a release location that is a movement destination, an obstacle O, a cardboard box C, and a tray T are displayed on the GUI, for example, the user inputs a restriction to an input unit 201 by designating a movable range of the target object M to a movement destination with a finger. The input unit 201 receives the input restriction. In this case, the fourth processing unit 202d acquires this restriction from the input unit 201 and adds this restriction to a restriction that has already been set. The fifth processing unit 202e performs a calculation process similar to that of the fifth processing unit 202e according to the first example embodiment for the movable range indicated in the added restriction.

Moreover, as shown in a portion of FIG. 12(b), it is assumed that the user inputs a restriction to the input unit 201 by designating one movable path from the target object M to the movement destination with a finger. The input unit 201 receives the input restriction. In this case, the fourth processing unit 202d acquires this restriction from the input unit 201 and adds this restriction to a restriction that has already been set. The fifth processing unit 202e performs a calculation process similar to that of the fifth processing unit 202e according to the first example embodiment for the path indicated in the added restriction. In a case where the fifth processing unit 202e cannot calculate a path that satisfies the restriction, the fifth processing unit 202e may notify the user that there is no path that satisfies the restriction.

In addition, the fifth processing unit 202e sets the obstacle O as an entry prohibition area of the target object M in a case where there is an obstacle whose height is determined to be high (for example, the obstacle O) in consideration of a restriction on the height at the step in which the restriction on the height is acquired from the fourth processing unit 202d. Also, the fifth processing unit 202e may issue an instruction to the input unit 201 so that the entry prohibition area is displayed on the GUI.

### Advantage

The robot system 1 according to the second example embodiment of the present disclosure has been described above. In the robot system 1, the fourth processing unit 202d acquires this restriction from the input unit 201 and adds this restriction to a restriction that has already been set. The fifth processing unit 202e performs a calculation process similar to that of the fifth processing unit 202e according to the first example embodiment for the movable range indicated in the added restriction.

Thereby, the robot system 1 can guide the target object M along a path that the user considers is unlikely to cause the target object M to fall.

### Modified Example of Second Example Embodiment

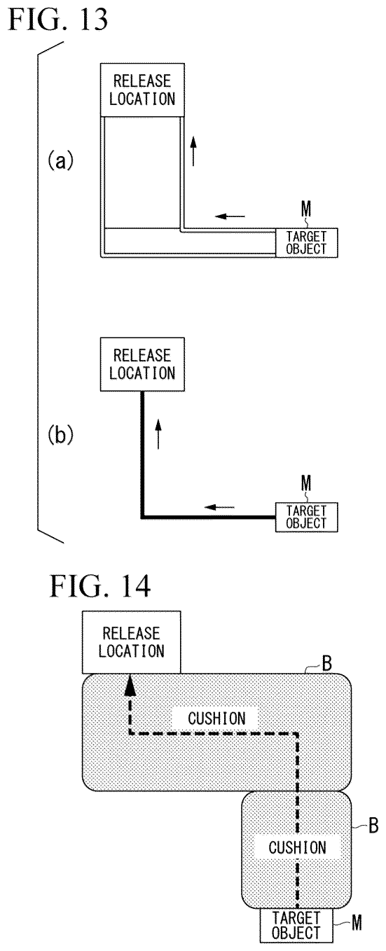

Next, a robot system 1 according to a modified example of the second example embodiment of the present disclosure will be described. In the robot system 1 according to the second example embodiment, the user may designate a movable range of the target object M to the movement destination using a feature object such as a guide tape. FIG. 13 is a diagram showing an example in which a restriction is designated using a feature object in the modified example of the second example embodiment of the present disclosure. For example, the imaging device 50 captures a feature object as shown in FIG. 13. The input unit 201 receives an image obtained by imaging the feature object. Also, the input unit 201 may identify a range in which a feature object is designated in an image as a restriction on the movable range of the target object M to the movement destination. It is only necessary for the fourth processing unit 202d to acquire this restriction from the input unit 201 and add this restriction to a restriction that has already been set. It is only necessary for the fifth processing unit 202e to perform a calculation process similar to that of the fifth processing unit 202e according to the first example embodiment for the movable range indicated in the added restriction. Thereby, the robot system 1 can guide the target object M along a path that the user considers is unlikely to cause the target object M to fall.

### Third Example Embodiment

Next, a robot system 1 according to a third example embodiment of the present disclosure will be described. The robot system 1 according to the third example embodiment includes a cushioning material B such as a cushion that reduces an impact even if a target object M falls in an area where movement of the target object M in a height direction is predicted to be greater than or equal to a threshold value. FIG. 14 is a diagram showing an example of an arrangement of the cushioning material B in the third example embodiment of the present disclosure. For example, a fifth processing unit 202e may issue an instruction to a control unit 203 so that the cushioning material B is arranged throughout an overall path that has been calculated. Moreover, for example, in a case where there is an obstacle whose height is determined to be high (for example, an obstacle O) in consideration of a restriction on the height at the step in which the restriction on the height is acquired from a fourth processing unit 202d, the fifth processing unit 202e may issue an instruction to the control unit 203 so that the cushioning material B is arranged around the obstacle O. In addition, the cushioning material B may be arranged by a user. Moreover, in the third example embodiment, for example, as described with reference to FIG. 12, the user may set a movement range of the target object M with respect to an input unit 201. Moreover, in an area where the cushioning material B is arranged in this way, the restriction on the height may be relaxed (specifically, an upper limit of the height may be raised).

### Advantage

The robot system 1 according to the third example embodiment of the present disclosure has been described above. The robot system 1 includes the cushioning material B such as the cushion that reduces the impact even if the target object M falls in the area where the movement of the target object M in the height direction is predicted to be greater than or equal to the threshold value.

Thereby, the robot system 1 can reduce a possibility of damage in a case where the target object M falls as compared to the robot system 1 in which the cushioning material B is not provided.

### Modified Example of Third Example Embodiment

Next, a robot system 1 according to a modified example of the third example embodiment of the present disclosure will be described. The robot system 1 according to the modified example of the third example embodiment may include an additional obstacle O that reduces the movement of the target object M in a height direction in an area where the movement of the target object M in the height direction is predicted to be greater than or equal to a threshold value. Thereby, the robot system 1 can reduce a possibility of damage in a case where the target object M falls as compared to the robot system 1 that does not include the additional obstacle O.

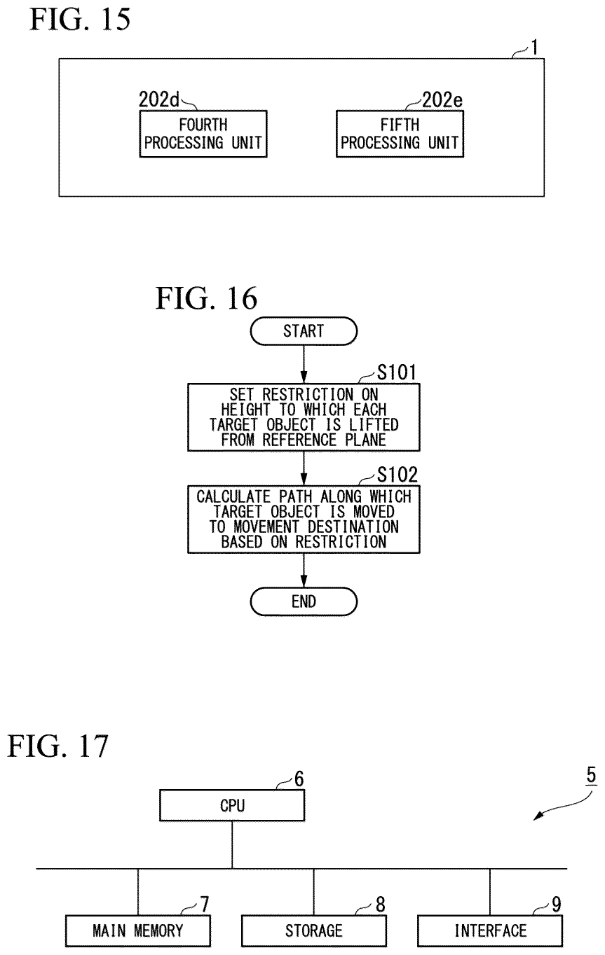

Next, a process of the robot system 1 having a minimum configuration according to the example embodiment of the present disclosure will be described. FIG. 15 is a diagram showing the robot system 1 having the minimum configuration according to the example embodiment of the present disclosure. The robot system 1 having the minimum configuration according to the example embodiment of the present disclosure includes a fourth processing unit 202d (an example of a setting means) and a fifth processing unit 202e (an example of a calculation means). The fourth processing unit 202d sets a restriction on a range of a height to which a target object M is lifted using a reference plane as a reference. The fourth processing unit 202d can be implemented, for example, using a function of the fourth processing unit 202d exemplified in FIG. 8. The fifth processing unit 202e calculates a path along which the target object M is moved to a movement destination based on a restriction set by the fourth processing unit 202d. The fifth processing unit 202e can be implemented, for example, using a function of the fifth processing unit 202e exemplified in FIG. 8.

Next, a process of the robot system 1 having the minimum configuration according to the example embodiment of the present disclosure will be described. FIG. 16 is a diagram showing an example of a processing flow of the robot system 1 having the minimum configuration according to the example embodiment of the present disclosure. Here, the process of the robot system 1 having the minimum configuration will be described with reference to FIG. 16.

The fourth processing unit 202d sets a restriction on a range of a height to which a target object M is lifted using a reference plane as a reference (step S101). The fifth processing unit 202e calculates a path along which the target object M is moved to a movement destination based on a restriction set by the fourth processing unit 202d (step S102).

The robot system 1 having the minimum configuration according to the example embodiment of the present disclosure has been described above. This robot system 1 can reduce a possibility of damage even if a target object falls while the robot is moving the target object to the movement destination.

Also, in the process in the example embodiment of the present disclosure, the order of processing may be swapped in a range in which the appropriate process is performed.

Although example embodiments of the present disclosure have been described, the above-described robot system 1, the control device 2, the input unit 201, the generation unit 202, the control unit 203, the management unit 204, the robot 40, the imaging device 50, and other control devices may include a computer device therein. The process of the above-described processing is stored on a computer-readable recording medium in the form of a program, and the above process is performed by the computer reading and executing the program. A specific example of the computer is shown below.

FIG. 17 is a schematic block diagram showing a configuration of a computer according to at least one example embodiment. As shown in FIG. 17, a computer 5 includes a central processing unit (CPU) 6, a main memory 7, a storage 8, and an interface 9. For example, each of the above-described robot system 1, the control device 2, the input unit 201, the generation unit 202, the control unit 203, the management unit 204, the robot 40, the imaging device 50, and other control devices is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

Although some or all of the above-described example embodiments may also be described as in the following supplementary notes, the present disclosure is not limited to the following supplementary notes.

### (Supplementary Note 1)

A robot system including:
a setting means configured to set a restriction on a range of a height to which a target object is lifted using a reference plane as a reference; and
a calculation means configured to calculate a path along which the target object will be moved to a movement destination based on the restriction set by the setting means.

### (Supplementary Note 2)

The robot system according to supplementary note 1, wherein in an area where the target object can move from a movement source to the movement destination, the reference plane is a surface of an obstacle capable of being confirmed in a height direction in an area where the obstacle is present and a floor surface in an area where the obstacle is absent.

### (Supplementary Note 3)

The robot system according to supplementary note 1, wherein the reference plane is a plane where a height serving as an absolute value in a height direction is uniform in an area where the target object can move from a movement source to the movement destination.

### (Supplementary Note 4)

The robot system according to any one of supplementary notes 1 to 3, including a reception means configured to receive a restriction on the height via a graphical user interface (GUI),
wherein the setting means sets a restriction on the height received by the reception means.

### (Supplementary Note 5)

The robot system according to any one of supplementary notes 1 to 4, wherein the setting means sets a restriction differing according to the height at a different point on the reference plane.

### (Supplementary Note 6)

The robot system according to any one of supplementary notes 1 to 5, including a cushioning material in an area where movement of the target object in a height direction is predicted to be greater than or equal to a threshold value.

### (Supplementary Note 7)

The robot system according to any one of supplementary notes 1 to 6, including an additional obstacle in an area where movement of the target object in a height direction is predicted to be greater than or equal to a threshold value.

### (Supplementary Note 8)

The robot system according to any one of supplementary notes 1 to 7, wherein the setting means sets a range of a path along which the target object will be moved to the movement destination designated by a user as a new restriction via a GUI.

### (Supplementary Note 9)

The robot system according to any one of supplementary notes 1 to 7, wherein the setting means sets a range of a path along which the target object will be moved to the movement destination designated by a user as a new restriction using a feature object.

### (Supplementary Note 10)

A processing method including:
setting a restriction on a range of a height to which a target object is lifted using a reference plane as a reference; and
calculating a path along which the target object will be moved to a movement destination based on the set restriction.

### (Supplementary Note 11)

A recording medium storing a program for causing a computer to:
set a restriction on a range of a height to which a target object is lifted using a reference plane as a reference; and
calculate a path along which the target object will be moved to a movement destination based on the set restriction.

### INDUSTRIAL APPLICABILITY

According to each example aspect of the present disclosure, it is possible to reduce a possibility of damage even if a target object falls while a robot is moving the target object to a movement destination.

### REFERENCE SIGNS LIST

1 Robot system
2 Control device
5 Computer
6 CPU
7 Main memory
8 Storage
9 Interface
40 Robot
50 Imaging device
201 Input unit
202 Generation unit
202a First processing unit
202b Second processing unit
202c Third processing unit
202d Fourth processing unit
202e Fifth processing unit
203 Control unit
204 Management unit
B Cushioning material
C Cardboard box
F Floor surface
M Target object
O Obstacle
T Tray

What is claimed is:

1. A robot system comprising:
a memory configured to store instructions; and
a processor configured to execute the instructions to:
set a restriction on a range of a height to which a target object is lifted using a reference plane as a reference; and
calculate a path along which the target object is moved to a movement destination based on the set restriction.

2. The robot system according to claim 1, wherein in an area where the target object is movable from a movement source to the movement destination, the reference plane is a surface of an obstacle capable of being confirmed in a height direction in an area where the obstacle is present and a floor surface in an area where the obstacle is absent.

3. The robot system according to claim 1, wherein the reference plane is a plane where a height serving as an absolute value in a height direction is uniform in an area where the target object is movable from a movement source to the movement destination.

4. The robot system according to claim 1, wherein the processor is configured to receive a restriction on the height via a graphical user interface (GUI); and
the processor is configured to set a restriction on the height.

5. The robot system according to claim 1, wherein the processor is configured to set a restriction to differ according to the height at a different point on the reference plane.

6. The robot system according to claim 1, further comprising a cushioning material in an area where movement of the target object in a height direction is predicted to be greater than or equal to a threshold value.

7. The robot system according to claim 1, further comprising an additional obstacle in an area where movement of the target object in a height direction is predicted to be greater than or equal to a threshold value.

8. The robot system according to claim 1, wherein the processor is configured to set a range of a path along which the target object is moved to the movement destination designated by a user as a new restriction via a graphical user interface (GUI).

9. The robot system according to claim 1, wherein the processor is configured to set a range of a path along which the target object is moved to the movement destination designated by a user as a new restriction using a feature object.

10. A processing method comprising:
setting a restriction on a range of a height to which a target object is lifted using a reference plane as a reference; and
calculating a path along which the target object is moved to a movement destination based on the set restriction.

11. A non-transitory recording medium storing a program for causing a computer to:
set a restriction on a range of a height to which a target object is lifted using a reference plane as a reference; and
calculate a path along which the target object is moved to a movement destination based on the set restriction.
